(19) United States
(12) Patent Application Publication
(10) Pub. No.: US 2016/0336644 A1
(43) Pub. Date: Nov. 17, 2016

(54) ANTENNA STRUCTURE AND WIRELESS COMMUNICATION DEVICE USING THE SAME

(71) Applicant: Chiun Mai Communication Systems, Inc., New Taipei (TW)

(72) Inventors: YI-CHIEH LEE, New Taipei (TW); YEN-HUI LIN, New Taipei (TW)

(21) Appl. No.: 14/710,797

(22) Filed: May 13, 2015

(51) Int. Cl. H01Q 1/24; H01Q 5/335

(52) U.S. Cl. CPC H01Q 1/243; H01Q 5/335

(57) ABSTRACT

A wireless communication device includes a metallic housing and an antenna structure. The antenna structure includes a feed end and a radiator. The radiator is connected to the feed end and extends towards the metallic housing. The metallic housing defines a gap between the metallic housing and the radiator for coupling the metallic housing with the radiator through electromagnetic induction. A size of the gap is determined by a wavelength of wireless signals received or transmitted by the wireless communication device. The radiator and the metallic housing cooperatively resonate in at least two modes.

### FIELD

The subject matter herein generally relates to antenna structures, and particularly to a multiband antenna structure, and a wireless communication device using the same.

### BACKGROUND

Antennas are used in wireless communication devices such as mobile phones. The wireless communication device uses a multiband antenna to receive/transmit wireless signals at different frequencies, such as wireless signals operated in an long term evolution (LTE) band.

### BRIEF DESCRIPTION OF THE DRAWINGS

Implementations of the present technology will now be described, by way of example only, with reference to the attached figures.

FIG. 1 is a diagrammatic view of a wireless communication device employing an antenna structure, according to a first exemplary embodiment.

FIG. 2 is a circuit view of a first matching circuit of the antenna structure of FIG. 1.

FIG. 3 is a circuit view of a second matching circuit of the antenna structure of FIG. 1.

FIG. 4 is a return loss (RL) graph of the antenna structure of FIG. 1.

FIG. 5 is a diagrammatic view of a wireless communication device employing an antenna structure, according to a second exemplary embodiment.

FIG. 6 is a return loss (RL) graph of the antenna structure of FIG. 5.

FIG. 7 is an antenna efficiency graph of the antenna structure of FIG. 1 and FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to an antenna structure and a wireless communication device using same.

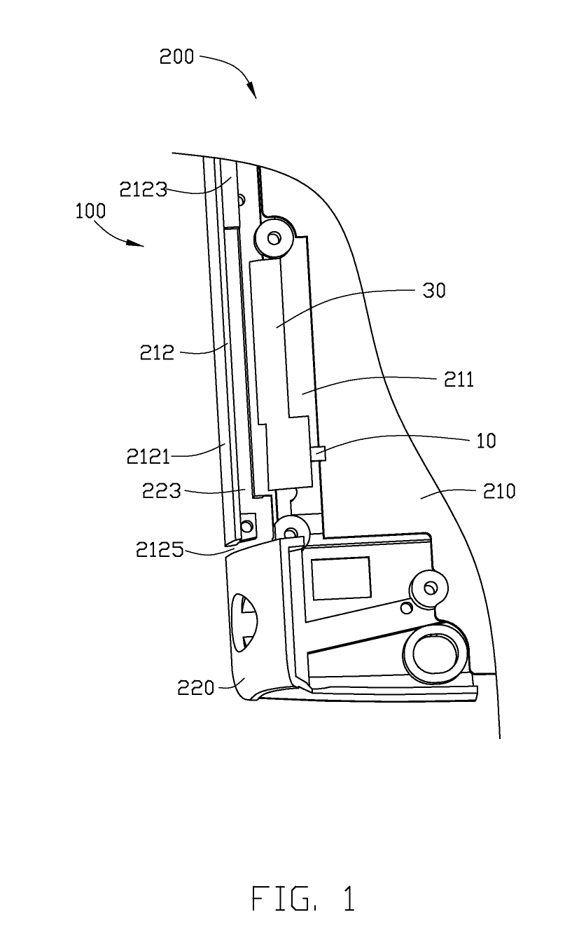

FIG. 1 illustrates an embodiment of a wireless communication device 200 employing an antenna structure 100, according to a first exemplary embodiment. The wireless communication device 200 can be a mobile phone, a tablet, or an intelligent watch, for example (details not shown). The wireless communication device 200 further includes a baseboard 210 and a metallic housing 220 surrounding the baseboard 210.

The baseboard 210 can be a printed circuit board (PCB) of the wireless communication device 200. The baseboard 210 includes a keep-out-zone 211 1 that is under a radiator 30 of the antenna structure 100. The purpose of the keep-out-zone 211 is to delineate an area on the PCB 210 in which other electronic components (such as a camera, a vibrator, a speaker, etc.) cannot be placed. Therefore, the keep-out-zone 211 does not include any electronic component, conductor or layout. In at least one embodiment, the keep-out-zone 211 is disposed on a side of the PCB 210.

In at least one embodiment, the metallic housing 220 is a middle frame of the wireless communication device 200 and is disposed on peripheral sides of the PCB 210. The metallic housing 220 includes at least one side plate 212. The at least one side plate 212 includes a boundary portion 2121 and an extending portion 2123 perpendicularly extending from the boundary portion 2121. The boundary portion 2121 defines an opening 2125. The extending portion 2123 defines a gap 223 between the radiator 30 and the metallic housing 220 for coupling the radiator 30 with the metallic housing 220 through electromagnetic induction. Consequently the metallic housing 220 serves as a part of the antenna structure 100. The gap 223 is substantially L-shaped communicating with the opening 2125, and a size of the gap 223 is determined by a wavelength of wireless signals received/transmitted by the wireless communication device 200. For example, a length of the gap 223 can be a quarter of the wavelength of the wireless signals received/transmitted by the wireless communication device 200. The opening 2125 and the gap 223 may be filled with any insulator material, such as air or plastic. Optionally, the PCB 210 is screwed onto the metallic housing 220 to allow the metallic housing 220 to be grounded via the PCB 210. In other embodiments, the metallic housing 220 can be a battery cover of the wireless communication device 200.

In at least one embodiment, the antenna structure 100 can be a monopole antenna, and includes a feed end 10 and the radiator 30. The feed end 10 is connected to a feed pin (not shown) of the PCB 210 to receive signals. The radiator 30 is perpendicularly connected to a distal end of the feed end 10 and extends towards the metallic housing 220. Additionally, the radiator 30 is spaced from the metallic housing 220, thus current can be coupled from the radiator 30 to the metallic housing 220 through electromagnetic induction. Optionally, the antenna structure 100 can be held by a plastic frame (not shown) of the wireless communication device 200.

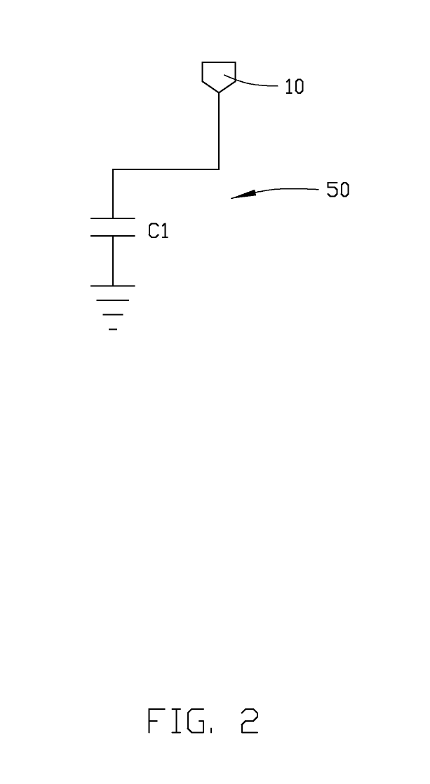

Further, referring to FIG. 2, a first matching circuit 50 can be incorporated into the antenna structure 100. The first matching circuit 50 includes a capacitor C1 electronically connected between the feed end 10 and the ground.

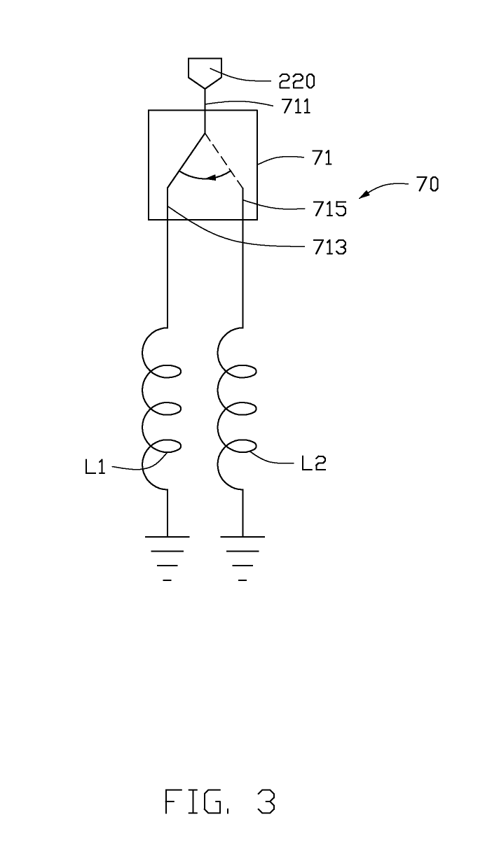

Moreover, referring to FIG. 3, a second matching circuit 70 can also be incorporated into the antenna structure 100. The second matching circuit 70 includes a single pole double throw (SPDT) switch 71, a first inductor L1, and a second inductor L2. The SPDT switch 71 includes a static contact 711, a first moving contact 713, and a second moving contact 715. The static contact 711 is electronically connected to the metallic housing 220, the first inductor L1 is electronically connected between the first moving contact 713 and the ground, and the second inductor L2 is electronically connected between the second moving contact 715 and the ground.

The first matching circuit 50 or/and the second matching circuit 70 can be incorporated into the antenna structure 100 to match an impedance of the antenna structure 100 for optimizing performance of the antenna structure 100.

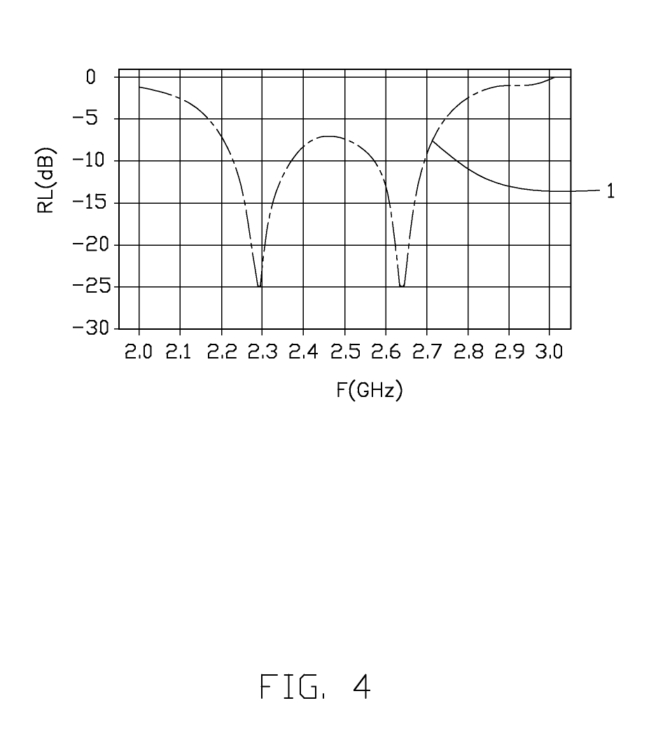

When current is input to the feed end 10, the current flows to the radiator 30, and then the radiator 30 and the first matching circuit 50 can resonate in a first mode. Additionally, the current is coupled from the radiator 30 to the metallic housing 220 for cooperatively resonating in a second mode. FIG. 4 illustrates a return loss (RL) curve 1 of the antenna structure 100. In at least one embodiment, when a capacitance of the capacitor C1 is about 2 pF, the antenna structure 100 is activated to receive and transmit long term evolution (LTE) signals at about 2300-2400 MHz and about 2500-2690 MHz. Additionally, the second matching circuit 70 can fine tune other bandwidths of the LTE signals.

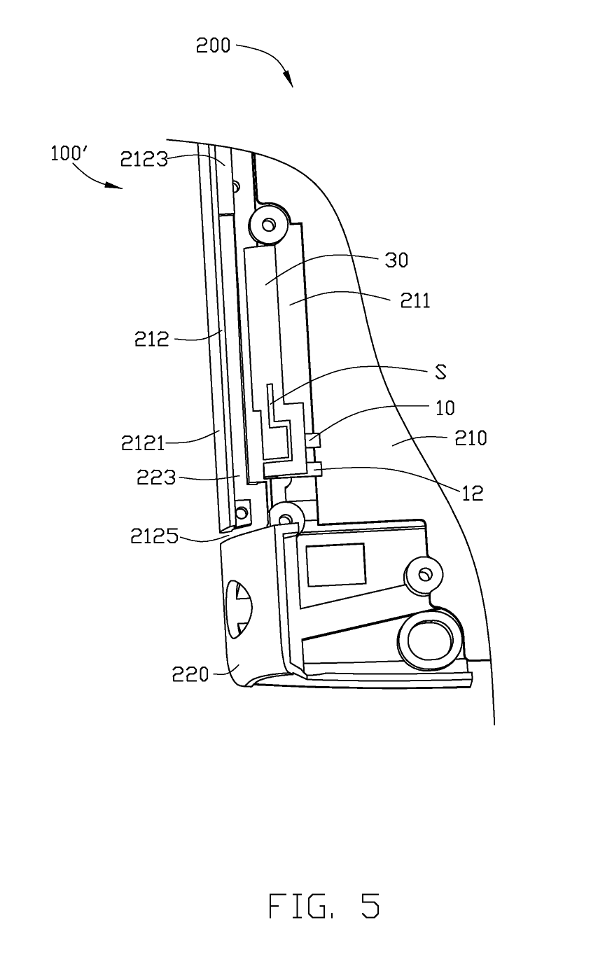

FIG. 5 illustrates an embodiment of an antenna structure 300, according to a second exemplary embodiment. The antenna structure 300 of the second exemplary embodiment is substantially same to the antenna structure 100 illustrated in the first exemplary embodiment, and a difference between the antenna structure 300 and the antenna structure 100 is that a ground end 12 is incorporated into the antenna structure 300. Thus, the antenna structure 300 can be a planar inverted F-antenna (PIFA), and is grounded via the ground end 12. The ground end 12 is substantially an L-shaped sheet and is connected between a ground pin (not shown) of the PCB 210 and the radiator 30. Additionally, the radiator 30 defines a slot S that splits an end of the radiator 30 into two prongs. The slot S changes the flow of current on the radiator 30, thus changing the mode of the antenna structure 300.

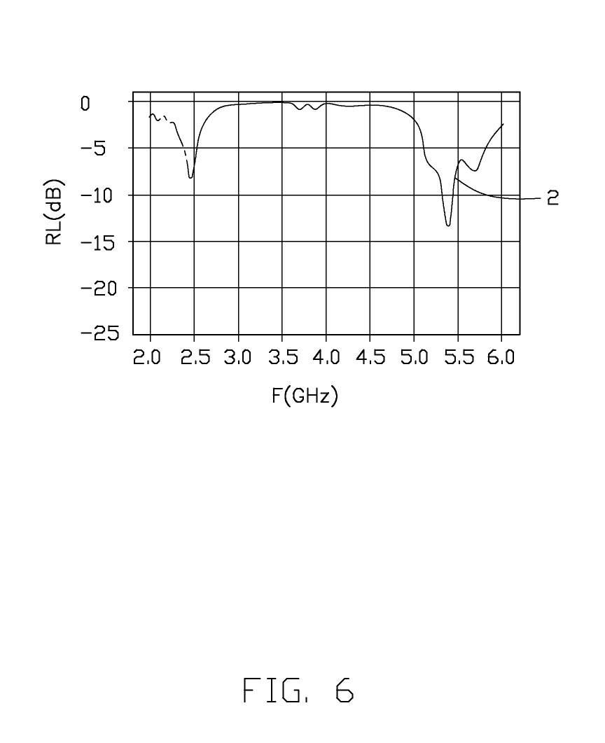

When current is input to the feed end 10, the current flows to the radiator 30, and then the current is coupled from the radiator 30 to the metallic housing 220 through electromagnetic induction. Thus, the radiator 30 and the metallic housing 220 can resonate in a third mode. Additionally, since the slot S is defined on the radiator 30, the radiator 30 and the metallic housing 220 further resonate in a fourth mode due to frequency-doubled effects of the radiator 30. FIG. 6 illustrates a return loss (RL) curve 2 of the antenna structure 300. In at least one embodiment, a central frequency of the third mode can be, for example, about 2400 MHz, and a central frequency of the fourth mode can be, for example, about 5000 MHz.

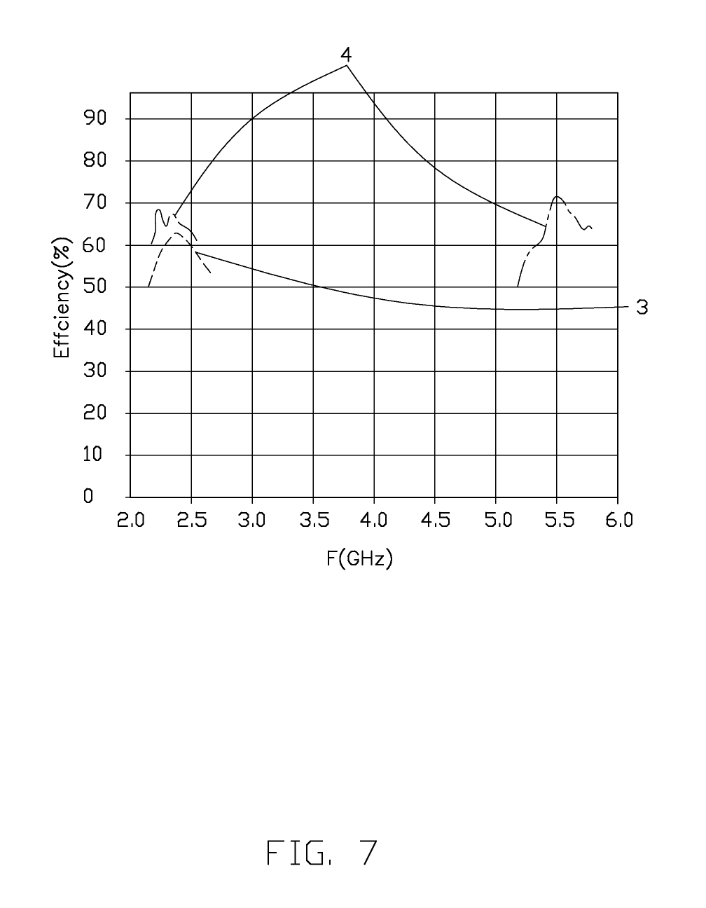

FIG. 7 illustrates an antenna efficiency of the antenna structures 100 and 300. A first antenna efficiency curve 3 indicates a radiation efficiency of the antenna structure 100, and a second antenna efficiency curve 4 indicates a total efficiency of the antenna structure 300. In view of the curves 3 and 4, the antenna structure 100 has good performance when operating at about 2300-2690 MHZ, the antenna structure 300 has good performance when operating at about 2400 MHZ and about 5000 MHZ.

In summary, the metallic housing 220 defines a gap 223 and is configured to be a part of the antenna structure 100 or 300, which allows further size reductions of the wireless communication device 200 employing the antenna structure 100 or 300. In addition, a radiating capability of the antenna structure 100 or 300 of the wireless communication device 200 is effectively improved because of the first matching circuit 50 and the second matching circuit 70.

The embodiments shown and described above are only examples. Many details are often found in the art such as the other features of the antenna structure and the wireless communication device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An antenna structure used in a wireless communication device having a metallic housing, the antenna structure comprising:
a feed end; and
a radiator coupled to the feed end and extending towards the metallic housing,
wherein the metallic housing defines a gap between the metallic housing and the radiator for coupling the metallic housing with the radiator through electromagnetic induction, a size of the gap is determined by a wavelength of wireless signals received or transmitted by the wireless communication device, and the radiator and the metallic housing cooperatively resonate in at least two modes.

2. The antenna structure as claimed in claim 1, wherein the antenna structure is a monopole antenna.

3. The antenna structure as claimed in claim 1, wherein the metallic housing comprises at least one side plate, the at least one side plate includes a boundary portion and an extending portion perpendicularly extending from the boundary portion, the gap is defined on the extending portion.

4. The antenna structure as claimed in claim 3, wherein the boundary portion defines an opening communicating with the gap.

5. The antenna structure as claimed in claim 1, further comprising a first matching circuit, wherein the first matching circuit comprises a capacitor electronically connected between the feed end and a ground.

6. The antenna structure as claimed in claim 1, further comprising a second matching circuit, wherein the second matching circuit comprises a single pole double throw (SPDT) switch, a first inductor, and a second inductor, the SPDT switch comprises a static contact, a first moving contact, and a second moving contact, the static contact is electronically connected to the metallic housing, the first inductor is electronically connected between the first moving contact and a ground, and the second inductor is electronically connected between the second moving contact and the ground.

7. The antenna structure as claimed in claim 1, wherein the antenna structure is a planar inverted F-antenna (PIFA) and further comprises a ground end, the ground end is substantially an L-shaped sheet and is connected to the radiator.

8. The antenna structure as claimed in claim 7, wherein the radiator defines a slot that splits an end of the radiator into two prongs.

9. A wireless communication device, comprising:
a metallic housing defining a gap; and
an antenna structure comprising:
a feed end; and
a radiator coupled to the feed end and extending towards the metallic housing;
wherein the gap is defined between the metallic housing and the radiator, the gap couples the metallic housing with the radiator through electromagnetic induction, a size of the gap is determined by a wavelength of wireless signals received or transmitted by the wireless communication device, and the radiator and the metallic housing cooperatively resonate in at least two modes.

10. The wireless communication device as claimed in claim 9, wherein the antenna structure is a monopole antenna.

11. The wireless communication device as claimed in claim 9, wherein the metallic housing comprises at least one side plate, the at least one side plate includes a boundary portion and an extending portion perpendicularly extending from the boundary portion, the gap is defined on the extending portion.

12. The wireless communication device as claimed in claim 11, wherein the boundary portion defines an opening communicating with the gap.

13. The wireless communication device as claimed in claim 9, wherein the antenna structure further comprises a first matching circuit, the first matching circuit comprises a capacitor electronically connected between the feed end and a ground.

14. The wireless communication device as claimed in claim 9, wherein the antenna structure further comprises a second matching circuit, wherein the second matching circuit comprises a single pole double throw (SPDT) switch, a first inductor, and a second inductor, the SPDT switch comprises a static contact, a first moving contact, and a second moving contact, the static contact is electronically connected to the metallic housing, the first inductor is electronically connected between the first moving contact and a ground, and the second inductor is electronically connected between the second moving contact and the ground.

15. The wireless communication device as claimed in claim 9, wherein the antenna structure is a planar inverted F-antenna (PIFA) and further comprises a ground end, the ground end is substantially an L-shaped sheet and is connected to the radiator.

16. The wireless communication device as claimed in claim 15, wherein the radiator defines a slot that splits an end of the radiator into two prongs.

17. The wireless communication device as claimed in claim 9, further comprising a baseboard, wherein the baseboard comprises a keep-out-zone disposed under the radiator, the keep-out-zone does not include any electronic component, conductor or layout, the metallic housing is disposed on peripheral sides of the keep-out-zone.
